(19) United States
(12) Patent Application Publication
(10) Pub. No.: US 2009/0185682 A1
(43) Pub. Date: Jul. 23, 2009

(54) SYSTEMS AND METHODS FOR IMPROVING HIGH- BANDWIDTH DIGITAL CONTENT PROTECTION (HDCP) AUTHENTICATION WITH DIGITAL VIDEO INTERFACE (DVI) OR HIGH-DEFINITION MULTIMEDIA INTERFACE (HDMI) RECEIVER DEVICES

(75) Inventors: Marcus Kellerman, San Diego, CA (US); Ronald A. Green, Irvine, CA (US)

Correspondence Address: Weiss & Arons, LLP, 1540 Route 202, Suite 8, Pomona, NY, 10970, US

(73) Assignee: Broadcom Corporation, Irvine, CA (US)

(21) Appl. No.: 12/017,085

(22) Filed: Jan. 21, 2008

(51) Int. Cl. H04N 7/167; H04K 1/00; H04L 9/32

(52) U.S. Cl. 380/201; 380/270; 380/258

(57) ABSTRACT

Systems and methods for improving HDCP (High-Bandwidth Digital Content Protection) authentication with DVI or HDMI receiver devices are provided. An HDCP transmitting apparatus according to the invention may include a computer and a look-up table accessible by the computer. The look-up table may include a database for storing an interoperability characteristic for an HDCP receiving device. The computer can communicate with the HDCP receiving device. The computer may also insert a delay in an initiation of the authentication and/or communication of content between the HDCP transmitting apparatus and the HDCP receiving device. The magnitude of the delay may be based on an interoperability characteristic retrieved from the look-up table that corresponds to the HDCP receiving device. The inserting may occur prior to the implementation of authentication initiation and ongoing link integrity checking between the transmitting apparatus and the HDCP receiving device.

### FIELD OF TECHNOLOGY

Aspects of the disclosure relate to High-bandwidth Digital Content Protection (“HDCP”).

### BACKGROUND

HDCP is a form of Digital Rights Management (DRM) developed by Intel Corporation of Santa Clara, Calif., to control digital audio and video content as it travels across a Digital Visual Interface (DVI), a High-Definition Multimedia Interface (HDMI), a Unified Display Interface (UDI) connection or any other suitable interface. The HDCP specification is proprietary, and creating an implementation of HDCP requires a license.

The HDCP authentication process, which takes place between a transmitting device and a receiving device, typically includes three parts:
1) Initial Authentication.
2) Authentication with daisy-chained downstream devices (used only if two or more devices are in a chain).
3) On-going integrity checking.

HDCP's main goal is to prevent transmission of non-encrypted high definition content. Three processes were developed to achieve that goal:

1) An authentication process was developed that prohibits non-licensed devices from receiving HD content; 2) Encryption of the actual data sent over DVI or HDMI interface prevents eavesdropping of information; and 3) “Man in the middle” are defended against.

Key revocation procedures ensure that devices manufactured by any vendors who violate the HDCP license agreement can be relatively easily blocked from receiving HD data.

Each HDCP-capable receiving device has a unique set of keys. There are 40 keys, each 56 bits long. These keys are confidential. For each set of keys, a special key called a KSV (Key Selection Vector) is created.

During the authentication process, both parties exchange their KSVs. Then each device adds its own secret keys together according to a KSV received from the other device. Keys and KSVs are generated in such a way that during this process both devices get the same multiple-bit number as a result. That number is later used in the encryption process.

The Initial Authentication is generally done over an I2C Bus contained in an HDMI connector. HDMI standards require that an HDMI transmitter initiate the Initial Authentication process as soon as the receiver of the HDMI signal makes its KSV value available on the receiver's I2C port.

After an exchange of KSVs and an exchange of a random start number between the transmitter and the receiver, an initial reference value R0 is generated on both the devices. The transmitter compares its reference R0 value to the receiver's R0 value as received over the I2C bus. If these two values are equal, the link is considered authenticated and the transmitter can begin sending encrypted content.

The part of the authentication referred to in the HDCP specification as “Ongoing Link Integrity Checking” uses the video signaling (TMDS¹ lines) to make sure the authentication is still valid. The link between the receiver and the transmitter is checked every 128 encrypted video frames when a new Rn value is created and checked in the same manner as R0 in the first part of the authentication. ¹Transition Minimized Differential Signaling (TMDS) is a technology for transmitting high-speed serial data and is used by the DVI and HDMI video interfaces, as well as other digital communication interfaces.

Encrypted video is sent by adding the video synchronization signal (“vsync”) to a control signal. It is this vsync signal that causes the HDMI transmitter to encrypt and the receiver to decrypt. At each vsync, each video frame is encrypted differently. Therefore, the transmitter and receiver must encrypt/decrypt on the same vsync.

The video signal is transmitted over a very high speed interface (TMDS). Because some DVI and/or HDMI receivers take some time to settle and lock to the TMDS signal, receivers may be unable to receive the encrypted video. This failure to settle and lock may result in a receiver erroneously interpreting too many or too few vsyncs. The result of these erroneous interpretations is a screen with random data or “snow.”

In such instances, the transmitter may eventually detect an error at R1, R2, etc. which can result in a retry of the entire authentication process. On a subsequent attempt, the receiver has already locked into the video signal and can, consequently, correctly interpret the vsyncs.

Such random data or snow is an annoyance at the startup of video after the HDMI cable has been plugged in or a immediately following a switch of video formats.

Accordingly, it would be desirable to provide systems and methods to alleviate and/or prevent the introduction of random data and/or snow during the locking on of the video signal.

### SUMMARY OF THE INVENTION

It is an object of this invention to provide systems and methods to alleviate and/or prevent the introduction of random data and/or snow during the locking on of the video signal.

A method according to the invention may be implemented at least to prevent the introduction of random data into an initiation sequence of an HDCP authenticated transmission. The HDCP transmission may be transmitted from an HDCP transmitting device to an HDCP receiving device.

The method may include identifying the HDCP receiving device and determining whether the identified HDCP receiving device is specified in a look-up table. The look-up table may be accessible to the transmitting device.

If the identified HDCP receiving device is specified in the look-up table, then the method may further include receiving a minimum magnitude of a delay required to prevent the introduction of random data into the HDCP transmission. The method may also include delaying implementation of the content transmission and/or ongoing link authentication by at least the minimum magnitude required to prevent the introduction of random data into the initiation sequence.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows a flow diagram of a first embodiment of a process according to the invention;

FIG. 3 shows a flow diagram of a second embodiment of a process according to the invention;

FIG. 4 shows a timing diagram of a process according to the invention; and

FIG. 5 shows a schematic diagram of a single or multi-chip module of this invention in a data processing system.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

One embodiment of the invention may preferably incorporate a short delay—e.g., between about 500 to about 1500 milliseconds, depending at least in part on the interoperability characteristic of the receiving device, or any other suitable time delay—following the identification of the receiving device and prior to video content transmission and/or on-going integrity checking.

Typically, inserting such a delay may increase the time between R0 and R1 to more than the 2048 millisecond delay that is normally seen between R0 and R1. Such an additional delay preferably allows the receiver to settle and lock on to the TMDS signal prior to receiving the encrypted video. Accordingly, when the encrypted video is first sent, no snow or other random data will be transmitted. Rather, the receiving device will continue to control the display output as it did prior to providing identification to the transmitting device until video content can be received properly. Thus, the inserted delay can provide for a much cleaner display and enhanced user experience.

In certain embodiments of the invention, look-up tables can be added to transmitting devices to check for known problematic receivers—e.g., certain makes and/or models of receivers that require a longer time to lock on to the incoming video signal. For each of the receivers identified in the look-up table, a corresponding minimum magnitude of delay in order to prevent the introduction of random data can be stored.

In particular embodiments of the invention, delay times can be based, for example, on device types or classes—e.g., DVI devices need longer delays than HDMI devices. Such embodiments may be implemented in addition to the embodiments that specify certain receivers in order to accommodate individual receivers, often with distinct interoperability characteristics, as well as classes of receivers.

Some embodiments of the invention may include distributing information relating to the magnitude of delays relevant to each receiving device and/or each class of receiving device to the various transmitting devices on a periodic basis. For example, information which preferably updates interoperability parameters can be distributed periodically using content-bearing devices such as DVDs and/or via downloads using broadcast systems such as set-top boxes.

In yet other embodiments of the invention, updatable interoperability parameters may be incorporated directly into the HDCP specification. As such, systems and methods according to the invention may provide an updatable and configurable system which may be used preferably continually as a platform to improve HDCP performance.

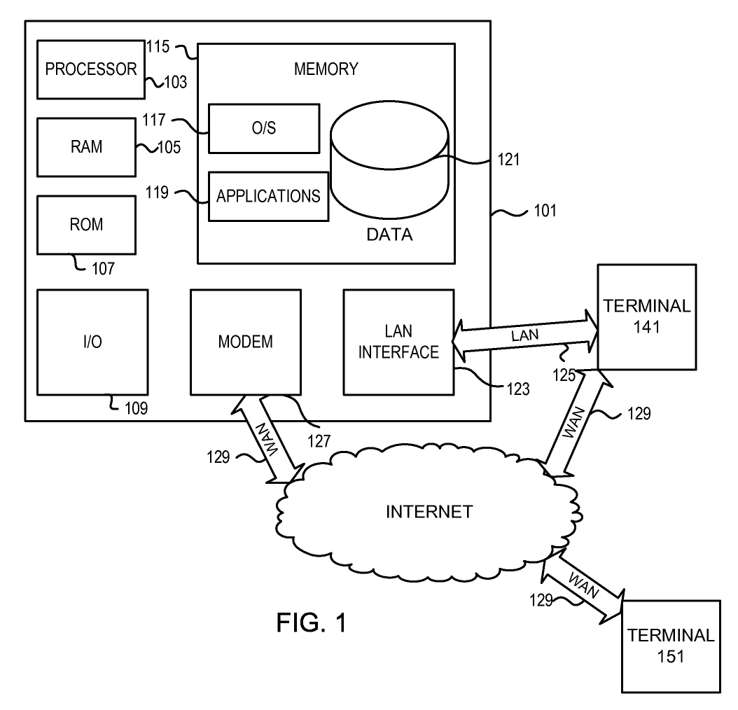

FIG. 1 illustrates a block diagram of a generic computing device 101 (which may also be a “server” and may be alternatively referred to herein as a “server”) that may be used according to an illustrative embodiment of the invention. Computing device 101 can form part of the HDCP transmitting device, the HDCP receiving device or be implemented at any other suitable location for any other suitable purpose in the HDCP transmission chain. The computer device 101 may have a processor 103 for controlling overall operation of its associated components, including RAM 105, ROM 107, input/output module 109, and memory 115.

I/O module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown).

Device (or server) 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119 used by server 101 according to an illustrative embodiment of the invention may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown). Computing device 101 may be used to implement various aspects of the invention. For example, computing device 101 may preferably incorporate systems and methods for receiving, arranging, storing, and transmitting updated interoperability characteristics to various transmitting devices. Alternatively, computing device 101 may preferably be implemented at the transmitters of the HDCP signal in order to receive the updated interoperability characteristics.

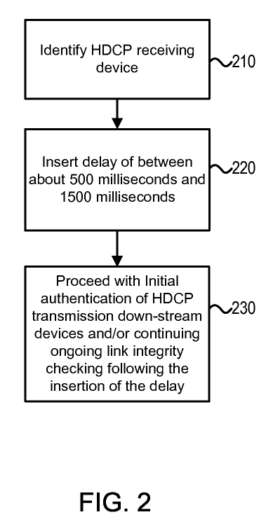

FIG. 2 shows an illustrative flow chart according to an embodiment of the invention. Step 210 shows identifying the HDCP receiving device. Step 220 shows inserting a delay of between about 500 milliseconds and about 1500 milliseconds preferably in order to allow the receiver to settle and lock on to the TMDS signal prior to receiving the encrypted video. Step 230 shows proceeding with initial authentication of HDCP receiving device, initiating down-stream devices and/or ongoing link integrity checking following the insertion of the delay. At this point, content transmission may preferably be initiated together with the ongoing link integrity checking.

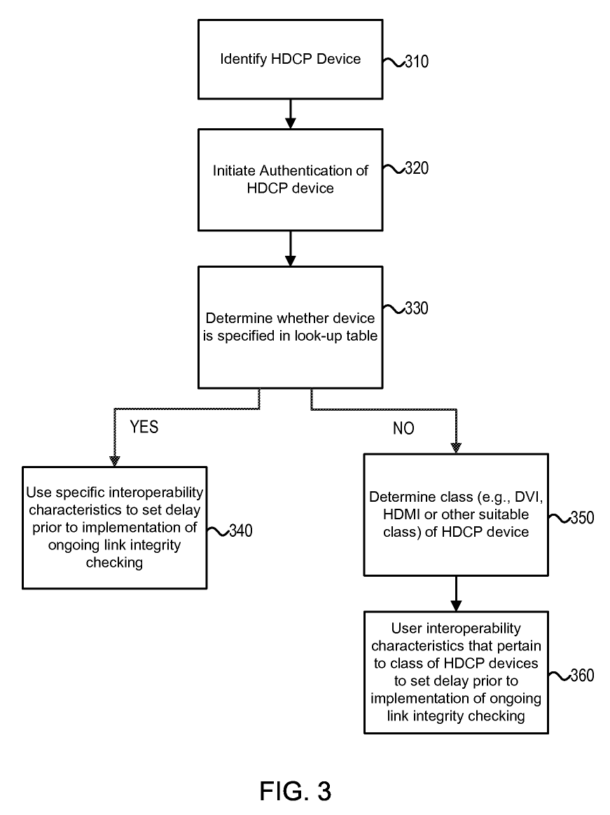

FIG. 3 shows an illustrative flow chart according to some embodiments of the invention. Step 310 shows identifying the HDCP receiving device. This identifying may be included in receiving the KSV from the receiving device. Step 320 shows initiating authentication of the HDCP receiving device.

It should be noted that the order of steps 310 and 320, as well as any of the steps shown in the flow charts described herein are not intended to restrict the invention to any one particular order of steps. Rather, wherever the steps of the invention are not specifically restricted to a particular order, it should be understood that the steps may be implemented in any way that satisfies the requirements of the invention.

Step 330 shows that, following the identification of the HDCP device, a determination can be made regarding whether the identified device is specified in a look-up table that may be stored in a computer according to the invention. If the HDCP is identified as one that is specified in the look-up table, then the specific interoperability characteristics as set forth in the look-up table may be used to determine the length of the delay necessary prior to initiating the ongoing link integrity checking, as shown in step 340.

If the HDCP device is not specified in the look-up table, then step 350 shows determining the class of the HDCP device—e.g., whether the device is a DVI, HDMI, or other suitably classified device. Step 360 shows using the interoperability characteristics that pertain to the predetermined class of HDCP devices in order to set the magnitude of the delay prior to implementation of the ongoing link integrity checking.

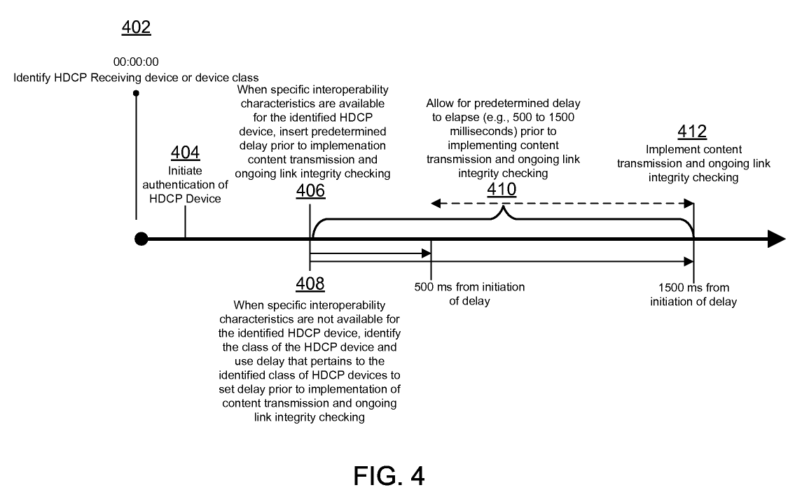

FIG. 4 shows a timing diagram that describes one embodiment of a process according to the invention. Step 402 shows identifying the HDCP receiving device and/or device class. Step 404 shows the initiation authentication of the HDCP device (alternatively referred to herein as initiating communication of content between an HDCP transmitting device and a selected HDCP receiving device.) It should be noted that steps 402 and 404 may not be required to be practiced in any particular order.

Step 406 shows that when specific interoperability characteristics are available for the identified HDCP device, the process may insert a predetermined delay prior to implementation of content transmission and ongoing link integrity checking. Step 408 shows that when specific interoperability characteristics are not available for the identified HDCP device, the process may identify the class of the HDCP device and use delay that pertains to the identified class of HDCP devices to set the delay prior to implementation of content transmission and ongoing link integrity checking.

Step 410 shows allowing for a predetermined delay to elapse (e.g., 500 to 1500 milliseconds) prior to implementing content transmission and ongoing link integrity checking. Step 412 shows implementing content transmission and ongoing link integrity checking following the conclusion of the delay period.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

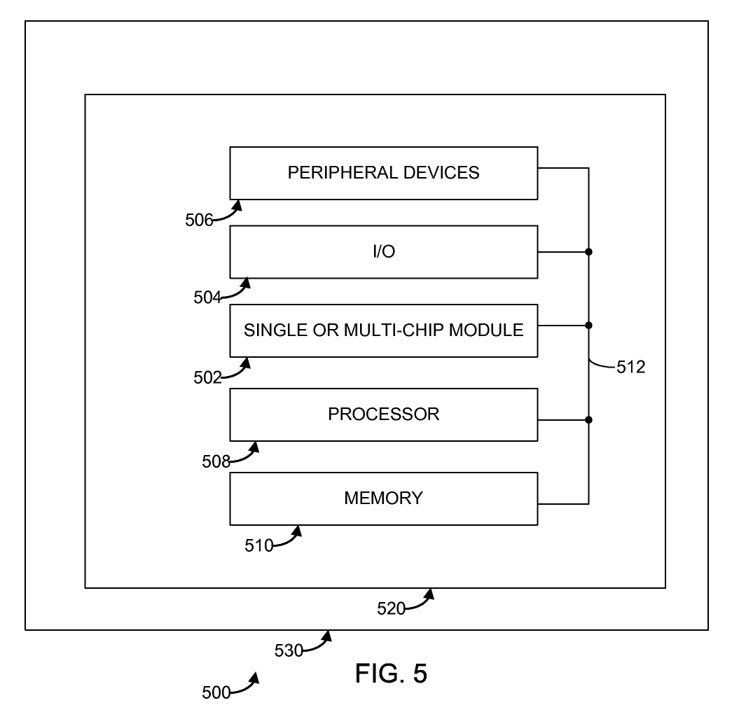

FIG. 5 shows a single or multi-chip module 502 according to the invention, which can be one or more integrated circuits, in a data processing system 500 according to the invention. Data processing system 500 may include one or more of the following components: I/O circuitry 504, peripheral devices 506, a processor 508 and memory 510. These components are coupled together by a system bus or other interconnections 512 and are populated on a circuit board 520 which is contained in an end-user system 530. System 500 is configured for use in a HDCP transmitting device according to the invention. It should be noted that system 500 is only exemplary, and that the true scope and spirit of the invention should be indicated by the following claims.

Thus, systems and methods for improving HDCP (high-bandwidth digital content protection) authentication with DVI or HDMI receiver devices according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. A method for preventing the introduction of random data into an initiation sequence of a High-Bandwidth Digital Content Protection (“HDCP”) receiving device, the method comprising:
using an HDCP transmitting bus to receive an HDCP receiving device key selection vector (KSV) from the HDCP receiving device via an I2C bus;
exchanging a random start number between the HDCP transmitting device and the HDCP receiving device
comparing a first reference value at the transmitting device to a first reference value at the receiving device;
if the first reference value at the transmitting device equals the first reference value R0 at the receiving device, delaying transmission of encrypted content from the HDCP transmitting device to the HDCP receiving device by a predetermined delay; and
transmitting the encrypted content from the HDCP transmitting device to the HDCP receiving device.

2. The method of claim 1 further comprising:
storing a look-up table, the look-up table that includes an interoperability characteristic for each of a plurality of HDCP receiving devices, the interoperability characteristic including a magnitude of the delay; and
using the look-up table to identify the interoperability characteristic of the HDCP receiving device.

3. The method of claim 1 further comprising using a look-up table to identify an interoperability characteristic of the HDCP receiving device.

4. The method of claim 1 further comprising identifying a minimum magnitude of the delay that prevents introduction of random data into the initiation sequence of the HDCP.

5. The method of claim 1 further comprising using a look-up table to determine whether the HDCP receiving device is a digital video interface (DVI) receiver device or a high-definition multimedia interface (HDMI) receiver device.

6. The method of claim 5 further comprising identifying a minimum magnitude of the delay that prevents introduction of random data into HDCP transmissions associated the determined class of HDCP receiving devices.

7. The method of claim 1 further comprising implementing the exchanging over the I2C bus.

8. A method for preventing the introduction of random data into an initiation sequence of a High-Bandwidth Digital Content Protection (“HDCP”) receiving device, the method comprising:
identifying the HDCP receiving device;
inserting a delay prior to initial authentication of the HDCP receiving device;
initiating authentication of an HDCP transmission; and
implementing ongoing link authentication.

9. The method of claim 8 further comprising:
storing a look-up table, the look-up table that includes an interoperability characteristic for each of a plurality of HDCP receiving devices, the interoperability characteristic including a magnitude of the delay; and
using the look-up table to identify the interoperability characteristic of the HDCP receiving device.

10. The method of claim 8 further comprising using a look-up table to identify an interoperability characteristic of the HDCP receiving devices.

11. The method of claim 8 further comprising identifying a minimum magnitude of the delay that prevents introduction of random data into the initiation sequence of the HDCP.

12. The method of claim 8 further comprising using a look-up table to determine whether the HDCP receiving device is a digital video interface (DVI) receiver device or a high-definition multimedia interface (HDMI) receiver device.

13. The method of claim 12 further comprising identifying a minimum magnitude of the delay that prevents introduction of random data into HDCP transmissions receiving devices associated with the determined class of HDCP receiving devices.

14. The method of claim 8 further comprising implementing the authentication over an I2C bus.

15. A method for preventing the introduction of random data into an initiation sequence of an HDCP authenticated transmission, the HDCP transmission being transmitted from an HDCP transmitting device to an HDCP receiving device, the method comprising:
identifying the HDCP receiving device;
determining whether the identified HDCP receiving device is specified in a look-up table, the look-up table being accessible to the transmitting device;
if the identified HDCP receiving device is specified in a look-up table, receiving a minimum magnitude of the delay required to prevent the introduction of random data into the HDCP transmission; and
delaying implementation of ongoing link authentication by at least the minimum magnitude of the delay.

16. The method of claim 15 further comprising, if the identified HDCP receiving device is specified in the look-up table, using a second look-up table to determine whether the HDCP receiving device is a digital video interface (DVI) receiver device or a high-definition multimedia interface (HDMI) receiver device.

17. The method of claim 15 further comprising identifying a minimum magnitude of the delay that prevents introduction of random data into the determined class of HDCP receiving devices.

18. The method of claim 15 further comprising implementing the identifying over an I2C bus.

19. An HDCP transmitting apparatus comprising:
a computer; and
a look-up table accessible by the computer, the look-up table comprising a database for storing an interoperability characteristic for each of a plurality of HDCP receiving devices;
wherein the computer is configured to communicate with a selected one of the plurality of HDCP receiving devices and to insert a delay in an initiation of the authentication between the HDCP transmitting apparatus and the selected one of the plurality of HDCP receiving devices, the magnitude of the delay being based on an interoperability characteristic retrieved from the look-up table that corresponds to the selected one of the plurality of HDCP receiving devices, the delay being inserted prior to the implementation of ongoing link integrity checking between the transmitting apparatus and the selected one of the HDCP receiving devices.

20. The apparatus of claim 19 wherein the interoperability characteristic is a predetermined delay.

21. The apparatus of claim 19, the predetermined delay that corresponds to the minimum magnitude of the delay that prevents introduction of random data into the initiation sequence of the HDCP.

22. The apparatus of claim 19 wherein the look-up table further comprises a database for storing an interoperability characteristic for each of a plurality of HDCP receiving device classes.

23. The apparatus of claim 22 wherein the computer is further configured to insert a delay in an initiation process of the communication, the magnitude of the delay being based on an interoperability characteristic retrieved from the look-up table that corresponds to a selected one of the plurality of HDCP receiving device classes.

24. The apparatus of claim 19 further comprising an I2C bus for coupling the transmitting apparatus and the selected one of the plurality of HDCP receiving devices.
